(19) United States
(12) Patent Application Publication
(10) Pub. No.: US 2025/0333989 A1
(43) Pub. Date: Oct. 30, 2025

(54) DISPLACEMENT DEVICE WITH A MOUNTING PROFILE AND FUNCTIONAL ENTITY

(71) Applicant: HAWA SLIDING SOLUTIONS AG, Mettmenstetten (CH)

(72) Inventor: Fabrice BÜHLER, Mettmenstetten (CH)

(73) Assignee: HAWA SLIDING SOLUTIONS AG, Mettmenstetten (CH)

(21) Appl. No.: 18/869,369

(22) PCT Filed: May 12, 2023
(86) PCT No.: PCT/EP2023/062854

§ 371 Date: Nov. 26, 2024

(30) Foreign Application Priority Data
Jun. 1, 2022 (EP) 22176722.1
Dec. 22, 2022 (EP) 22216211.7

(51) Int. Cl. E05D 15/58; E05F 11/04; E06B 3/50

(52) U.S. Cl. CPC E05D 15/581; E05F 11/04; E06B 3/509; E05D 2015/586; E05Y 2201/654; E05Y 2201/664; E05Y 2201/668; E05Y 2201/672; E05Y 2201/684; E05Y 2900/14; E05Y 2900/212

(57) ABSTRACT

The displacement device (10), which is provided for the installation in a door compartment (18) of a functional entity (1), comprises a drive device (2) preferably comprising a housing (210), a spring mechanism (211), a pull cord pulley (212) coupled to the spring mechanism (211), and a pull cord (22), which is wound onto the pull cord pulley (212) and is guided preferably via at least one deflection pulley (231, 232, 233) up to a holding element (33, 339; 72), a mounting profile (14),
which is connected or connectable by mounting hinges (131) to a single-part or multi-part door (11), which is held vertically aligned and displaceable by a holding device (4);
which is connected on an upper end piece to an upper guide carriage (5) that is supported displaceably on an upper guide rail (15) and/or
which is connected on a lower end piece to a lower guide carriage (6) that is supported displaceably on a lower guide rail (16); and
which, connected to the drive device (2), is automatically displaceable between a rear-sided end position (S2) at the rear-side of the displacement device (10) and a front-sided end position (S1) at the front-side of the displacement device (10); and

an adjustment device (3, X3), with which a pre-tension on the spring mechanism (211) of the drive device (2) can be set. According to the invention the adjustment device (3, 3X) is arranged separated from the drive device (2) and comprises an adjustment element (33, X33) which is rotatable and lockable or displaceable and lockable and which adjustment element (33, X33) cooperates with the pull cord (22) led out of the drive device (2) in such a way that the pull cord (22) is pullable out of the drive device (2) by rotation or displacement of the adjustment element (33, X33) to set a corresponding pre-tension of the spring mechanism (211).

The invention relates to a displacement device with a mounting profile, which is connected to a single-part or multi-part door, possibly a foldable sliding door, which is held vertically aligned and automatically displaceable within a door compartment, and to a functional entity, in particular a piece of furniture or a room unit, which comprises at least one such displacement device.

For closing openings of functional units, such as pieces of furniture, room units, kitchens or sleeping corners, single-part of multi-part doors are often used, possibly foldable sliding doors, which are moved into a door compartment of the functional entity after the opening has been released, so as not to disturb in appearance.

U.S. Pat. No. 8,336,972B2 discloses a piece of furniture with a displacement device with which a mounting profile connected to a one-piece door is displaceable within a door compartment. The displacement device comprises a holding device in the form of a scissor cross by means of which the mounting profile is held displaceable in vertical orientation. The displacement device further comprises running rails along which the mounting profile is displaceably supported by means of carriages.

U.S. Pat. No. 9,284,761B2 discloses a piece of furniture with a displacement device with which a mounting profile connected to a foldable sliding door is displaceable within a door compartment. The foldable sliding door comprises two door elements, of which the first door element is connected at the rear by mounting hinges to the mounting profile and at the front by door hinges to the rear of the second door element, which is connected at the front to a running gear displaceable along a running rail having two rail sections aligned perpendicularly to each other and interconnected by a curved section, of which a first rail section extends into the door compartment and a second rail section extends along the front of the piece of furniture.

EP1394349A1 discloses a displacement device for a door element, which is connectable turntable with a displaceable mounted mounting profile, which is held perpendicular to the displacement direction by means of two flexible connecting elements.

Also known are displacement devices in which a mounting profile connected to a sliding door is automatically displaceable within a door compartment by means of a drive device.

WO2021119696A1 discloses a guide arrangement for at least one door leaf of a piece of furniture, comprising a guide rail on which a drive device is arranged by means of which the door leaf is movable.

DE202020107104U1 discloses a further guide arrangement for at least one door leaf of a piece of furniture with a drive device comprising a pull cord for driving the movably supported piece of furniture, a pull cord drum for winding and unwinding the pull cord, a spring mechanism for driving the pull cord drum, and an adjustment device for adjusting a pre-tension of the spring mechanism. The adjustment device is integrated into the drive device. Hence, manufacturing of the drive device is associated with a higher effort. This is particularly important if several drive devices with different specifications are to be provided. Furthermore, it should be noted that the adjustment of the pre-tension requires access to the drive device installed into the piece of furniture. Hence, the drive device must be mounted appropriately or intervention in the piece of furniture will be required.

The present invention is therefore based on the task of creating an improved displacement device with a drive device comprising a pull cord connected to a spring mechanism, by means of which a mounting profile connected or connectable to a single-part or multi-part door is automatically displaceable within a door compartment of a functional entity, a piece of furniture or a room unit.

Furthermore, a functional entity, a piece of furniture or a room unit, shall be provided with at least one improved displacement device by means of which a mounting profile connected to a door, possibly a foldable sliding door, is automatically displaceable within a door compartment of the functional entity.

The inventive displacement device shall allow to advantageously adjust a pre-tension of the spring mechanism by means of an adjustment device to influence the movement of the mounting profile during displacement.

The drive device shall be cost-effective to manufacture and shall require as little maintenance as possible over a long period of operation.

The displacement device shall be easy to install so that the drive device with the pull cord can easily be put into operation.

The displacement device shall advantageously be adjustable by skilled personnel as well as by users, so that the mounting profile can be driven with a desired force within a preferably adjustable path. In particular, the displacement device shall advantageously be adaptable to different loads exerted by door elements connected to the mounting profile.

This task is solved with a displacement device according to claim 1 and an improved functional entity according to claim 15, which has at least one door compartment with a displacement device according to claim 1 arranged therein. Advantageous embodiments of the invention are specified in further claims.

The displacement device, which is provided for the installation in a door compartment of a functional entity, comprises

a drive device comprising, in preferred embodiments a housing, a spring mechanism, a pull cord pulley coupled to the spring mechanism, and a pull cord, which is wound onto the pull cord pulley and guided, preferably via at least one deflection pulley, up to a holding element,

a mounting profile,
which is connected or connectable by mounting hinges to a single-part or multi-part door, which is held vertically aligned and displaceable by a holding device;
which is connected on an upper end piece to an upper guide carriage that is supported displaceably on an upper guide rail and/or which is connected on a lower end piece to a lower guide carriage that is supported displaceably on a lower guide rail; and
which, connected to the drive device, is automatically displaceable between a rear-sided end position at the rear-side of the displacement device and a front-sided end position at the front-side of the displacement device; and

an adjustment device, with which a pre-tension on the spring mechanism of the drive device can be set.

According to the invention the adjustment device is arranged separated from the drive device and comprises an adjustment element which is rotatable and lockable or displaceable and lockable and which adjustment element cooperates with the pull cord led out of the drive device in such a way that the pull cord is pullable out of the drive device by rotation or displacement of the adjustment element to set a corresponding pre-tension of the spring mechanism (211).

The adjustment device for setting the pre-tension is not integrated in the drive device but is realised by means which are arranged outside the drive device and by means of which the pull cord can be pulled out of the drive device or its housing in order to set a pre-tension on the spring mechanism. The spring mechanism is thus pre-tensioned by unwinding the pull cord from the pull cord pulley, turning the pull cord pulley and tensioning the spring mechanism accordingly.

A complex drive device with an integrated device for adjusting the pre-tension is therefore not required. The drive device can therefore be designed to be simpler, more space-saving and also more robust and can be manufactured more simply and cheaply. Hence, maintenance work and repair of the drive device even after a long period of operation can normally be avoided.

It is particularly advantageous that the parts of the adjustment device to be adjusted can be arranged on an advantageously accessible part of the displacement device.

The range in which the pre-tension of the spring mechanism can be adjusted is not specified by a manufacturer but can be freely selected for the inventive displacement device.

By means of the drive device the mounting profile can be moved automatically in one direction towards the front-sided end position or alternatively in the other direction towards the rear-sided end position. The pre-tension of the spring mechanism causes it to act with a higher tensile force on the pull cord and the mounting profile is moved with a higher or lower force, for example, from the rear end position towards the front-end position. The adjustment of the pre-tension is preferably done taking into account the weight of the door connected to the mounting profile. The adjustment of a desired pre-tension can be achieved by different measures. The adjustment of a pre-tension can be done stepwise, for example by means of a latching device, or continuously.

In a first basic embodiment of the invention, an adjustment device with a rotatable adjustment element, namely a rotatable pull cord drum, is provided. In a second basic embodiment of the invention, an adjustment device with a displaceable adjustment element, namely a displaceable deflection unit, is provided.

The first adjustment device tensions the spring mechanism by shortening the length of the pull cord, which is wound onto the pull cord pulley inside the drive device and guided to the first adjustment device. For this purpose, the free end of the pull cord, which is led out of the housing of the drive device, is wound onto the rotatable pull cord drum, as required.

With the second adjustment device the spring mechanism is tensioned by lengthening or shortening the path along which the pull cord runs from the drive device to the stationary holding element by moving a deflection unit.

When the first or second adjustment devices are actuated, the pull cord is pulled out of the housing of the drive device or released again to adjust the pre-tension of the spring mechanism.

The displacement device preferably comprises two adjustment devices, preferably a first adjustment device with a rotatable adjustment element and a second adjustment device with a displaceable adjustment element. One of the adjustment devices is preferably used for the coarse adjustment of the pre-tension and the other adjustment device is preferably used for the fine adjustment of the pre-tension. Preferably, the coarse adjustment of the pre-tension is carried out by means of a displaceable adjustment element and the fine adjustment by means of a rotatable adjustment element.

In the first basic embodiment of the invention, the first adjustment device is preferably stationary at the front-end position of the displacement device at the access to the door compartment. The first adjustment device has a housing with a housing chamber in which the pull cord drum is mounted so that it can conveniently be turned about its longitudinal axis, hereinafter referred to as the drum axis, and then locked.

The locking of the pull cord drum can be realised in different ways. Preferably, locking elements are provided on the pull cord drum which can cooperate with at least one counter element on the housing, and which can be released from each other, for example, by axial displacement of the pull cord drum or by displacement of the at least one counter element, in order to be able to rotate the pull cord drum.

Preferably, it is provided that the upper guide rail is connected at the front-end to an upper stop device, which determines the front-sided end position of the displacement device, or that the lower guide rail is connected at the front-end to a lower stop device, which determines the front-sided end position of the displacement device, or in that the upper guide rail is connected at the front-end to an upper stop device and the lower guide rail is connected at the front-end to a lower stop device, which determine the front-sided end position of the displacement device, and in that the adjustment device is mounted on the upper stop device or on the lower stop device or is integrated in the upper stop device or in the lower stop device. The adjustment device mounted on the upper or lower stop device is therefore easily accessible at the front side of the piece of furniture. A desired pre-tension of the drive device can therefore conveniently be adjusted.

The pull cord drum is preferably connected on a first side coaxial to the drum axis with a tool coupling part, which is preferably aligned against the front side of the displacement device and thus against the front side of the piece of furniture and thereby easily accessible for coupling a tool and rotating or pushing and rotating the pull cord drum.

The housing chamber preferably comprises a tool chamber, in which the tool coupling part is held rotatable and displaceable, a locking chamber, into which at least one counter element, such as a holding nose, a wing or rib, preferably integrally connected to the housing, projects, and a drum chamber, in which the pull cord drum is held rotatable and preferably axially displaceable.

The pull cord drum preferably comprises a preferably cylindrical winding body onto which the pull cord can be wound, and to which a first drum wall is connected on one side and a second drum wall on the other side. The first drum wall is preferably integrally connected to the tool coupling part and preferably integrally connected to at least one locking element which is turnable within the locking chamber against the at least one counter element. The second drum wall preferably rests on an elastic element, such as a drum spring, preferably a coil spring, which presses the pull cord drum against the locking chamber, so that the at least one locking element lies in the engagement area of the counter element and can only be released from the locking chamber if the pull cord drum is moved back axially by exerting a counter pressure. Preferably, several cooperating locking elements are provided on the first drum wall and/or several counter elements on the housing, so that an adjustment in correspondingly small steps is possible.

In a preferred embodiment, the pull cord drum has, adjacent to the second drum wall, a threaded rod coaxially aligned with the drum axis, by which a slider is held rotatable. The housing of the adjustment device has a bushing chamber in which a bearing bush is held, which has a bushing channel into which the threaded rod projects and within which the slider is held axially displaceable but not turnable and is displaceable by rotation of the pull cord drum in one and/or the other direction to an end stop.

Preferably, the slider has at least one slider wing which projects into a bushing slot adjacent to the bushing channel and is displaceably guided therein parallel to the drum axis. The slider is therefore held non-rotatable but displaceable along the bushing slot until it encounters a first or second end stop, formed for example by the housing, a part of the bearing bush, possibly the ends of the bushing slot or the pull cord drum.

In a further preferred embodiment, the housing chamber of the housing is closable by a cover which is preferably complementary to the housing.

A locking element such as a mounting fork can preferably be inserted into the cover, with which the pull cord drum and the drum spring can be fixed to the cover. The pull cord drum and the drum spring can therefore be placed on the cover, fixed by means of the locking element or mounting fork and then easily inserted into the housing of the adjustment device. The locking element or mounting fork is then removed, and the drum spring activated. The activated drum spring then abuts on the one side preferably the second drum wall and on the other side preferably a part of the housing.

In the second principal embodiment of the invention, the displaceable adjustment element of the adjustment device is a deflection unit,
which holds a first deflection pulley via which the pull cord is guided from the drive device to a second deflection pulley and further to a stationary holding element,
which is directly or indirectly connected to the mounting profile, which is displaceably mounted with respect to the drive device and with respect to the second deflection pulley that is directly or indirectly connected to the mounting profile or to one of the guide carriages.

The pre-tension of the spring mechanism is therefore adjustable by moving and locking the deflection unit.

The pull cord is preferably guided from the housing of the drive device to the first deflection pulley and preferably at least approximately parallel back to the second deflection pulley. Preferably, the pull cord runs at least approximately parallel to the mounting profile. The pull cord thus runs with a first part preferably parallel to the mounting profile and with a second part preferably parallel to the lower and/or upper guide rail.

The axes of rotation of the first and second deflection pulley, which are held by bearing shafts, are parallel or inclined, preferably perpendicular to each other. In this way, the pull cord can be guided in a particularly advantageous way, especially parallel to the mounting profile, and horizontally to the holding element.

Preferably, the end piece of the pull cord remote from the drive unit or from the housing of the drive unit is provided with a coupling part, a hook, an anchor, a latching element, a rod or a loop, which can be connected, hooked or latched into the holding element. In this way, the pull cord can be mounted in a few simple steps.

The deflection unit is preferably held in a form-fitting and/or force-fitting manner in a guide channel of the mounting profile displaceable and lockable. The deflection unit is thus preferably displaceable parallel to the longitudinal axis of the mounting profile and fixable in a suitable position by means of a locking device, such as a fixing screw. For example, a part of the body of the deflection unit corresponding or complementary to the guide channel engages positively in the guide channel. Due to the length of the guide channel, which preferably extends over the entire length of the mounting profile, there is a correspondingly large adjustment range that can be covered by moving the deflection unit with a hand movement.

The holding element for the connection of the pull cord is preferably arranged on a stop device, which is preferably mounted on the front side of the upper or lower guide rail and which forms with a stop buffer an end stop for the upper or lower guide carriage.

By providing the holding element for the pull cord on the stop device, it is ensured that the pull cord is guided close to the adjacent guide rail and the space inside the door compartment is kept largely free. The inventive displacement device therefore allows different holding devices to be used advantageously.

Regardless of the design of the inventive displacement device, the drive device is preferably connected to the mounting profile and is displaceable with the mounting profile parallel to the guide rails. However, according to the invention, it is also possible to mount the drive device stationary and to guide the pull cord to the first or second adjustment device via a deflection pulley provided on the mounting profile.

The drive device is preferably arranged laterally next to the mounting profile or laterally next to one of the guide carriages in relation to the displacement axis of the mounting profile or in relation to the driveway of the mounting profile. This arrangement of the drive device avoids a shortening of the driveway. It is avoided that the housing of the drive device additionally contributes to the loss depth of the cabinet body through the mounting profile.

The drive device can also be fully or partially be integrated into the associated guide carriage, so that an even more compact design of the displacement device can be realised.

In preferred embodiments, the spring mechanism of the drive device is a driving spring, such as a helical spring or a spiral spring, and that the pull cord of the drive device is wound on a pull cord pulley, which is rotatably mounted and connected to the spring mechanism, whereby by rotation of the pull cord pulley in one direction the spring mechanism can be tensioned and by rotation of the pull cord pulley in the other direction the displacement device can be released. With regard to the inventive displacement device, however, it is immaterial how the pull cord is arranged in the drive device and how the spring mechanism is designed.

Preferably, two identical or similarly acting drive devices are provided, which are firmly connected to the mounting profile or to one of the guide carriages and are displaceable together with the mounting profile, and which each have a pull cord, which is guided from the associated drive device directly or via a first deflection pulley or via the first deflection pulley and a second deflection pulley to an associated holding element, which is arranged stationary at the front or rear end position of the driveway, and is connected thereto.

The use of two preferably mirror-inverted or symmetrically arranged drive devices has various advantages. The space requirement of the second drive device is therefore also minimal. The drive forces of the drive devices add up, thus allowing the mounting profile with the connected door to be moved with a higher acceleration. Instead of one larger drive device, two smaller drive devices can also be used, each of which takes up less space and therefore takes up less space with a greater overall drive power or allows the moving part of the displacement device to be realised with a smaller cross-section. The space requirement of the displacement device inside the door compartment can paradoxically be reduced by using two drive devices. By using two drive devices, torques caused by the first drive device can also be compensated for, so that the drive effect is further increased.

The holding devices described above comprise, for example, a scissor cross or a parallelogram or, as shown in the embodiments, two holding ropes by means of which the mounting profile is held vertically aligned.

The inventive displacement device can be used for any functional entity that concerns a lockable space and that is usually enclosed by walls or partitions. The inventive displacement device is compact and takes up little space, so that the associated door compartment can also be realised with small dimensions and extended usable space remains in the functional entity. The door compartment can therefore accommodate small as well as large single or multi-part doors, possibly foldable sliding doors, which are connected to the mounting profile by mounting hinges.

A functional entity can have one or more door compartments. For example, door compartments are provided on both sides of the functional entity, which limit the usable space of the functional entity. A door compartment can also have two sliding devices with single-part or multi-part doors, possibly foldable sliding doors, by means of which a usable space of the functional entity can be closed off on both sides of the door compartment.

Functional units can have spaces delimited by wooden walls and furniture, especially cupboards. On the other hand, functional entities can also have spaces delimited by walls, which can be closed off by means of one-part or multi-part doors, possibly foldable sliding doors.

The installed displacement device is preferably designed in such a way that the actuation of the first and second adjustment device can take place on the front side of the functional entity.

The invention is explained in more detail below with reference to the drawings. Thereby shows:

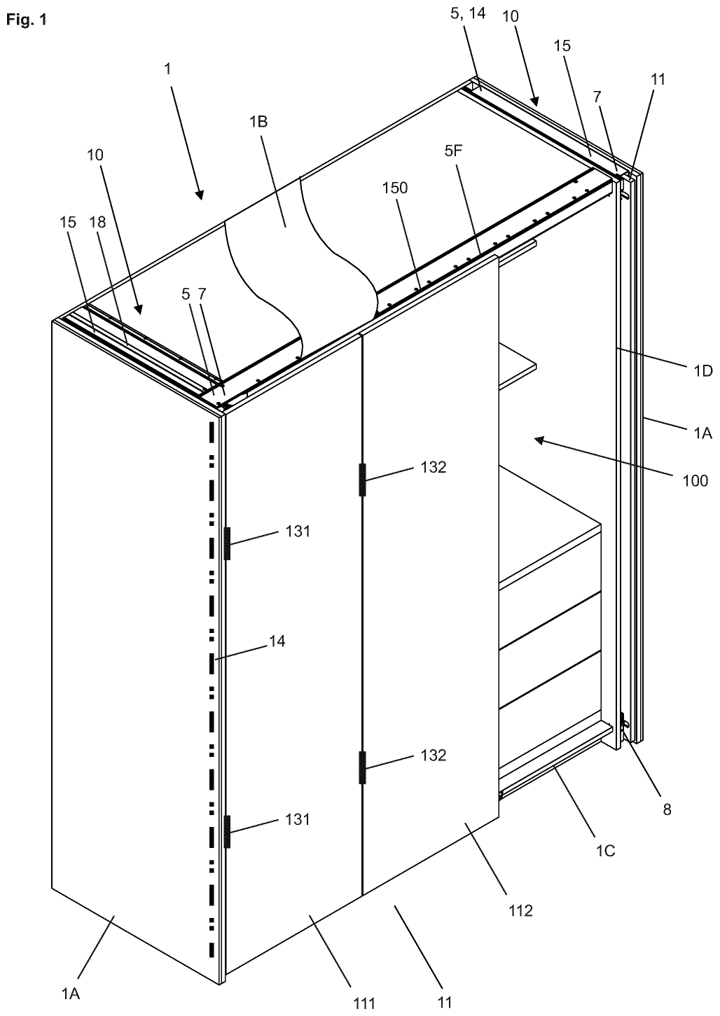

FIG. 1 an inventive functional entity 1 in the form of a piece of furniture with a first door compartment 18, in which a mounting profile 14, which is connected to a foldable sliding door 11, is held automatically displaceable by means of an inventive displacement device 10, and a second door compartment 18, in which a further mounting profile 14, which is connected to a one-piece door 11, is held automatically displaceable by means of an inventive displacement device 10;

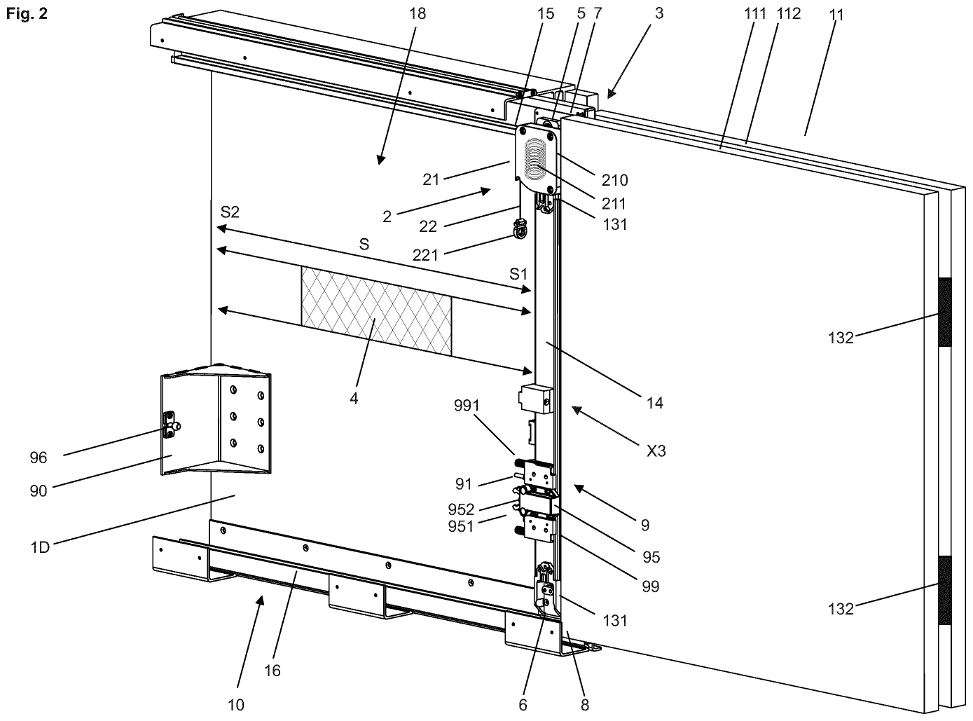

FIG. 2 the displacement device 10 arranged in the first door compartment 18 of the functional entity 1 of FIG. 1 with the mounting profile 14, which is connected to a drive device 2 and optionally with an auxiliary drive 9, which is held in vertical alignment by a holding device 4, and which is connected to the foldable sliding door 11 by mounting hinges 131;

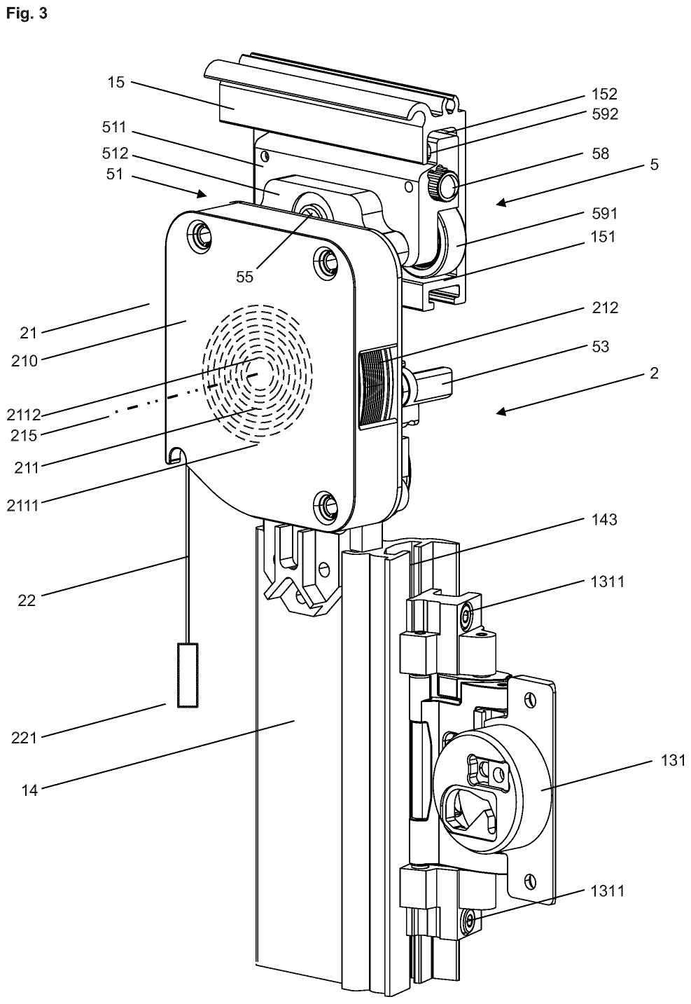

FIG. 3 a part of the displacement device 10 of FIG. 2 with the upper end piece of the mounting profile 14 connected to an upper guide carriage which is displaceably supported in an upper guide rail 15 and which is connected to a drive device 2 comprising a drive unit 21 holding a pulley 212 coupled to a displacement device 211, connected to a spring mechanism 211 and being wrapped by a pull cord 22;

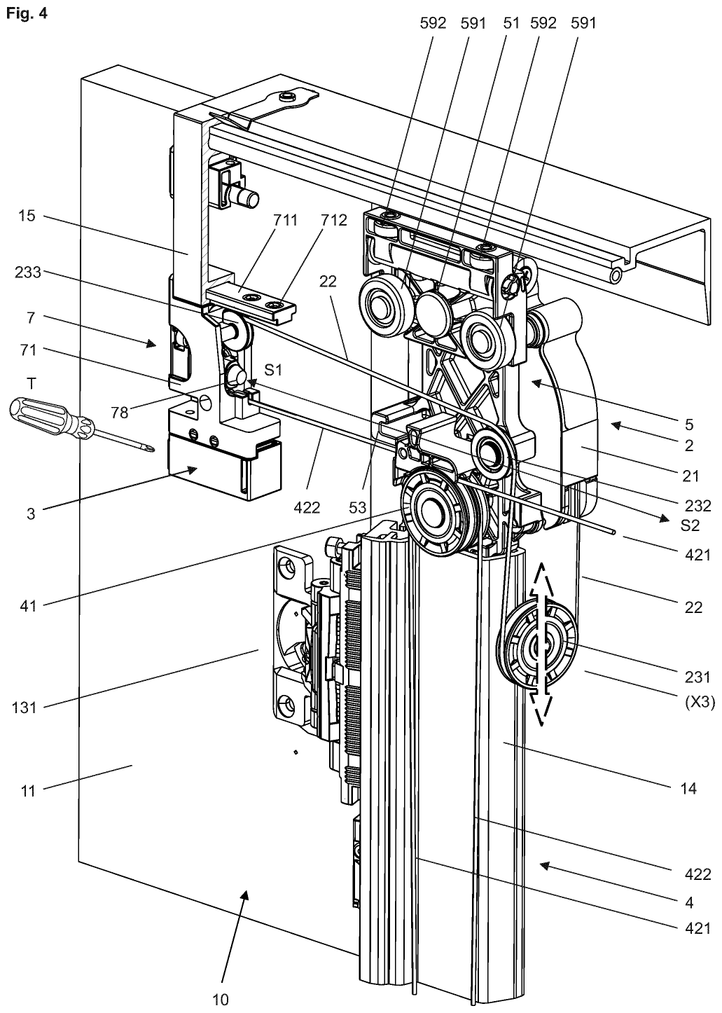

FIG. 4 the displacement device 10 of FIG. 2 with a preferably provided holding device 4 and with the mounting profile 14 connected to the drive device 2, from which the pull cord 22 is guided via three pulleys 231, 232 and 233 to a first adjustment device 3 mounted on an upper front-sided stop device 7;

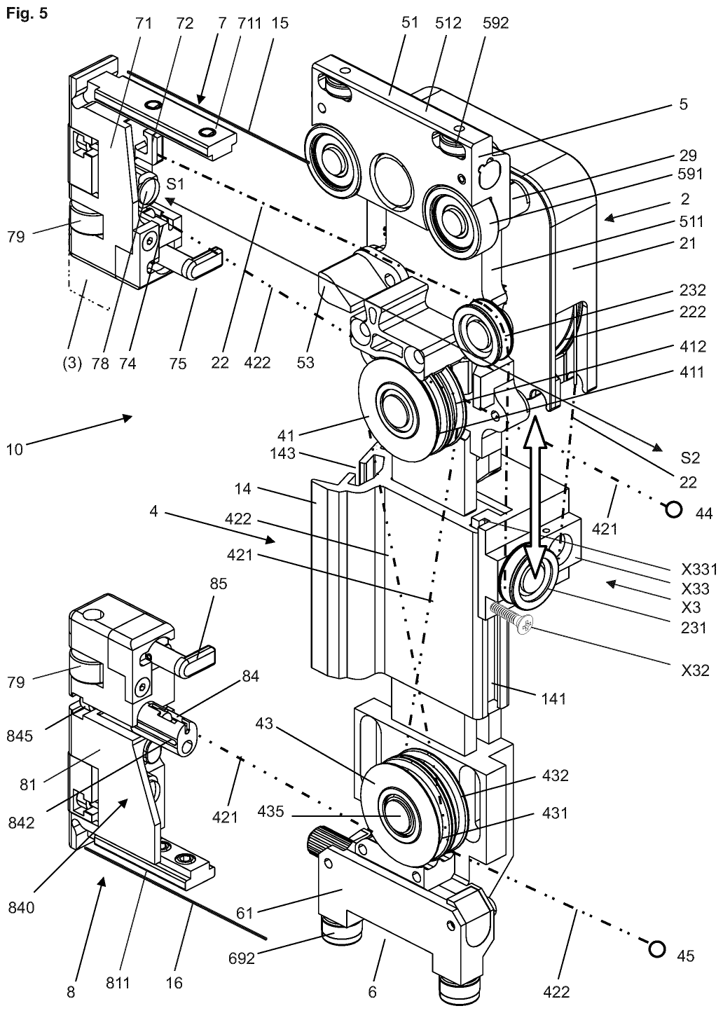

FIG. 5 the displacement device 10 of FIG. 2 with a preferred holding device 4 and with the mounting profile 14, which is connected to the drive device 2, from which the pull cord 22 is guided via a second adjustment device X3, which has a deflection unit X33 that is displaceable along the mounting profile 14 and can be locked, to a holding element 72, which is arranged on the upper front-sided stop device 7;

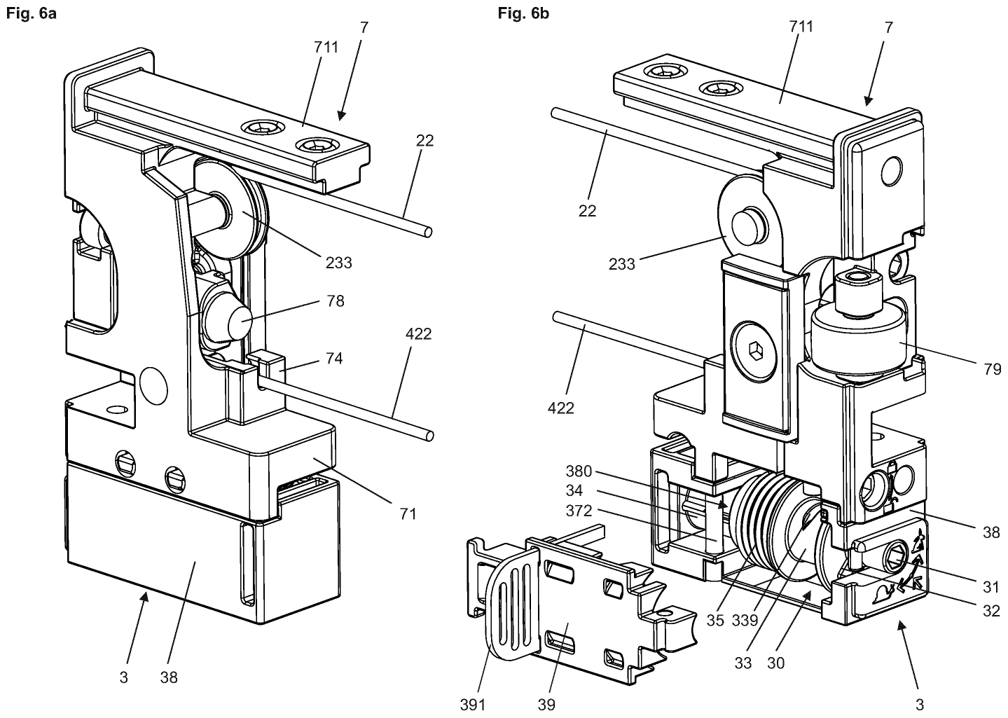

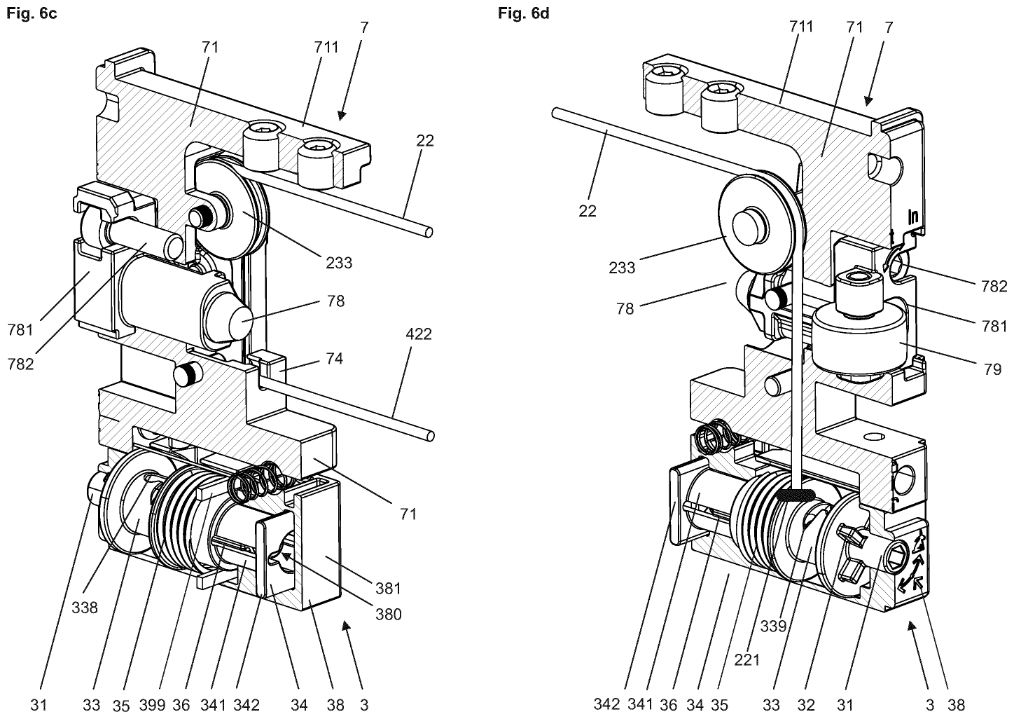

FIG. 6a the upper front-sided stop device 7 and the associated first adjustment device 3 of FIG. 4 from the rear side;

FIG. 6b the upper front-sided stop device 7 and the associated first adjustment device 3 of FIG. 6a with a detached cover 39 from the front side, from which the first adjustment device 3 is adjustable;

FIG. 6c the upper front-sided stop device 7 and the associated first adjustment device 3 of FIG. 6a in a sectional view;

FIG. 6d the upper front-sided stop device 7 and the associated first adjustment device 3 of FIG. 6b in a sectional view;

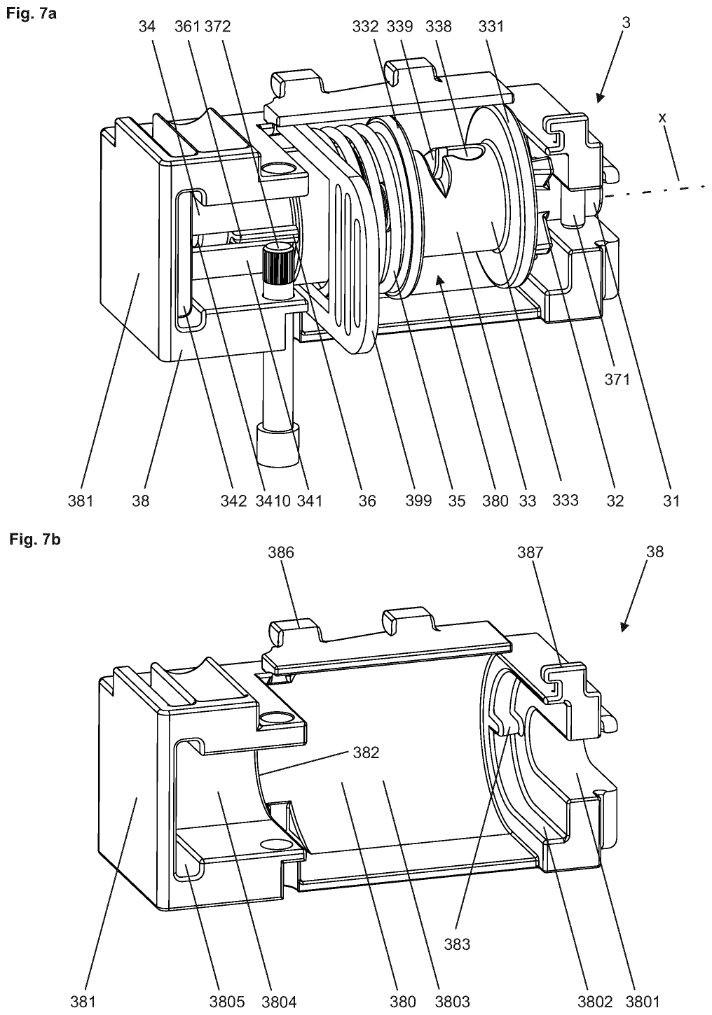

FIG. 7a the first adjustment device 3 of FIG. 6b without cover 39;

FIG. 7b the housing 38 of the first adjustment device 3 of FIG. 7a;

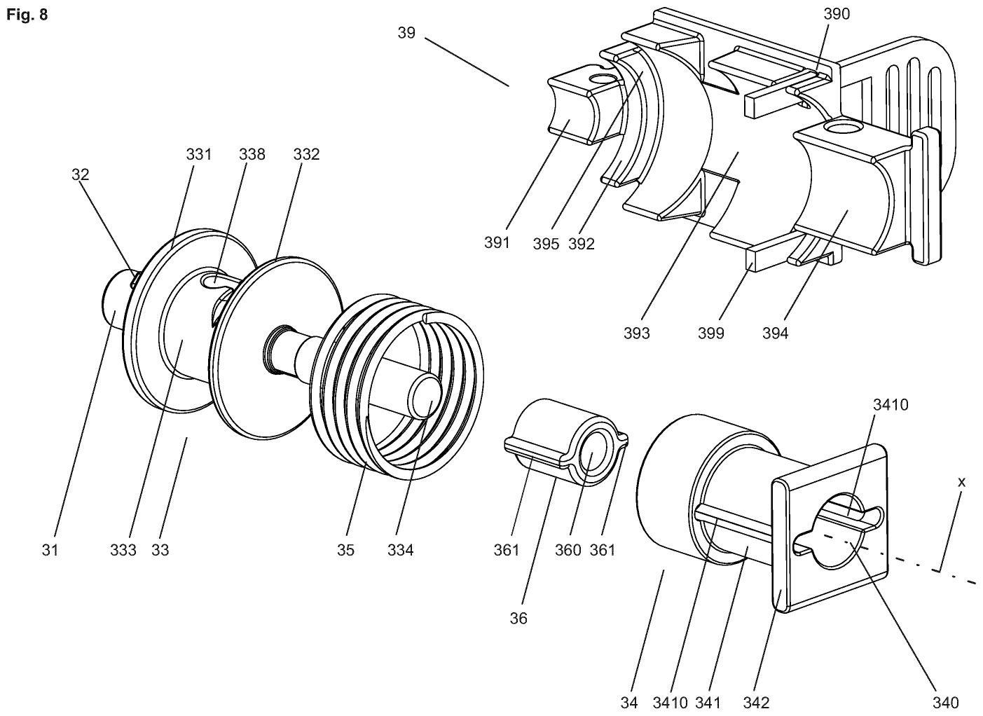

FIG. 8 the pull cord drum 33, the bearing bush 34, the drum spring 35, the slider 36 and the cover 39 of the first adjustment device 3 of FIG. 7a in exploded view;

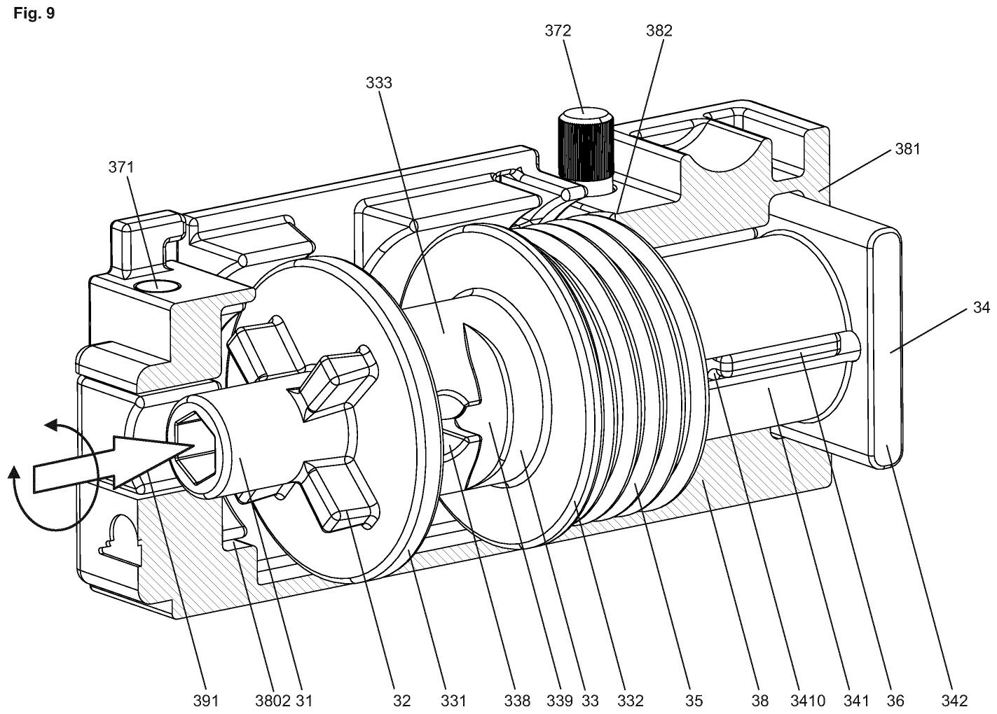

FIG. 9 the first adjustment device 3 of FIG. 4 during the process of adjusting the pre-tension on the drive device 2; and

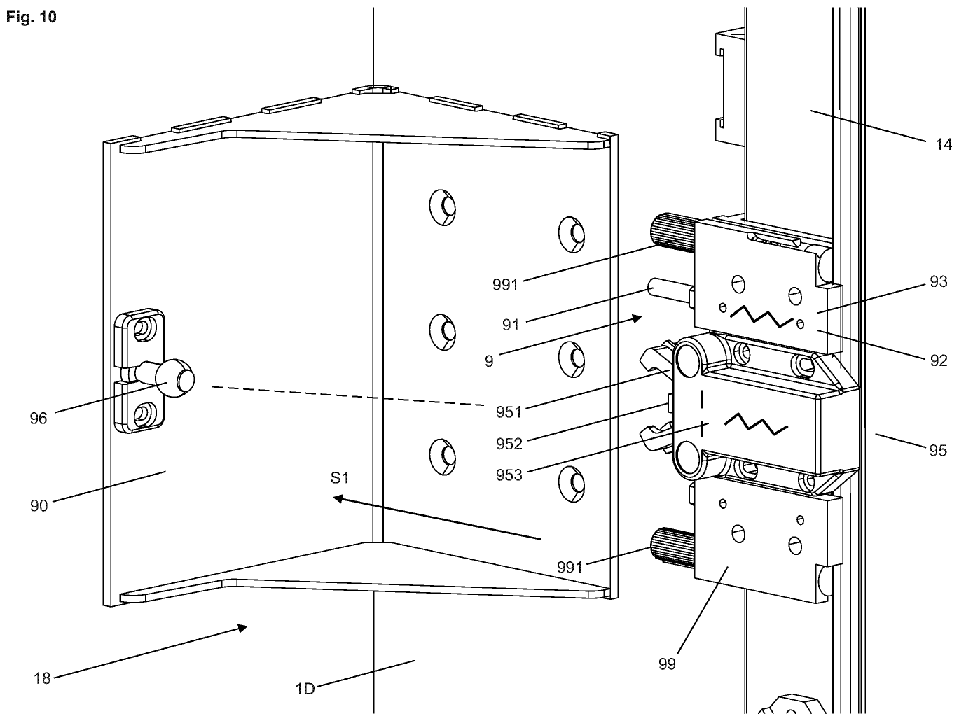

FIG. 10 the auxiliary drive 9 of FIG. 2, which is held by the mounting profile 14 and which cooperates with a rear stop device 90 after the sliding door 11 has been pushed into the door compartment 18.

FIG. 1 shows an inventive functional entity or a piece of furniture 1 in the form of a wardrobe in which a door compartment 18 is integrated on each side. The piece of furniture 1 comprises side walls 1A, an upper board 1B, a lower board 1C and partitions 1D, each of which delimits a door compartment 18 with an associated side wall 1A. In each door compartment 18 an inventive displacement device 10 with a mounting profile 14 is arranged, which is automatically displaceable within the door compartment 18 without an electric drive motor. Doors 11 are held by the mounting profile 14, which are retracted into or extended from the associated door compartment 18 when the mounting profile 14 is displaced.

A foldable sliding door 11 is held in the first door compartment 18, which has a first and a second door element 111, 112 that are hinged to each other. The door 11 held inside the second door compartment 18 by a mounting profile 14, on the other hand, has only one door element and is thus designed as a single piece.

The foldable sliding door 11 is fully extended from the first door compartment 18 and fully unfolded so that the door elements 111, 112 are aligned in one plane. The door elements 111, 112 of the foldable sliding door 11 and the door element of the single-part door 11 are of equal size. The foldable sliding door 11 shown in the closed position covers therefore two thirds of the cabinet opening 100.

The trailing edge of the first door element 111 of the foldable sliding door 11 is connected by mounting hinges 131 to the mounting profile 14 shown symbolically, which is held at the front-end position of the displacement device 10 at the exit of the door compartment 18 after the sliding door 11 has been moved out.

The leading edge of the first door element 111 is connected by door hinges 132 to the trailing edge of the second door element 112, whose leading edge is connected at the top to a front carriage 5F. The front carriage 5F is guided in a support rail 150. When entering the door compartment 18 and when travelling along the support rail 150, the front carriage 5F runs ahead, whereby the change of direction takes place within a curved section.

FIG. 2 shows the displacement device 10 arranged in the first door compartment 18 of the functional entity 1 of FIG. 1 with the mounting profile 14, which is connected to a drive device 2 and optionally to an auxiliary drive 9, which is held in vertical alignment by a holding device 4 shown symbolically, and which is connected to the foldable sliding door 11 by the mounting hinges 131.

The mounting profile 14 is displaceable along a driveway S between the front-end position S1 at the front side of the door compartment 18 and a rear end position S2 at the rear side of the door compartment 18.

As shown in FIG. 5, the mounting profile 14 is preferably connected at the upper end piece with an upper guide carriage 5, which is guided in an upper guide rail 15, and at the lower end piece with a lower guide carriage 6, which is guided in a lower guide rail 16. The upper guide carriage 5 comprises support rollers 591 and guide rollers 592 and has a support function in addition to the guide function. The lower guide carriage 6 comprises a lower carriage body 61 with guide rollers 692, which are guided in the lower guide rail 16.

In FIG. 2, the upper guide carriage 5 and the lower guide carriage 6 abut at the front-end position S1 against an upper stop device 7 and a lower stop device 8, which are shown in FIG. 5.

At the rear end position S2, a stop device 90 is provided with a stop plate which limits the driveway S of the mounting profile 14 at the rear of the door compartment 18.

The inventive displacement device 10 comprises a drive device 2 with a pull cord 22, which is connected inside the housing 210 of the drive device 2 to a spring mechanism 211, and which is not yet mounted in FIG. 2. By means of this drive device 2, the mounting profile 14 is displaceable preferably over the entire driveway S. For the adjustment of a pre-tension at the spring mechanism 211 a first adjustment device 3 and/or a second adjustment device X3 are provided, which are described in more detail below. These adjustment devices 3, X3 are located outside of the housing 210 of the drive device 2 and allow the pull cord 22 to be pulled out of the drive device 2. The displacement device 10 can therefore be equipped with simple and universal drive devices 2, which have a pull cord 22 with a spring mechanism 211 but no integrated adjustment device.

An even more advantageous movement of the mounting profile 14 can be achieved if a drive device 2 is not only provided at the upper end of the mounting profile 14 or at the upper guide carriage 5, but preferably also at the lower end of the mounting profile 14 or at the lower guide carriage 6 with a functionally identical or identical drive device 2. It is desirable to have a high acceleration at the beginning and then a smooth movement of the mounting profile 14.

Optionally, an auxiliary drive 9 is provided to support the at least one drive device 2 in the area of the rear end position S2. As soon as the mounting profile 14 is released from the rear end position S2 or from the stop device 90, it is additionally accelerated over a relatively short distance by the auxiliary drive 9. The auxiliary drive 9 realises a rapid movement sequence. The mounting profile 14 does not move sluggishly from the rear end position S2 but is accelerated quickly. The auxiliary drive 9 preferably has an extendable piston 91, which is supported by a spring that stores the drive energy.

Above and below the auxiliary drive 9, damping devices 99 are provided, comprising a damping piston 991 which is displaced upon impact with the stop device 90 and dampens the movements of the mounting profile 14 and avoids a disturbing impact.

Between the two damping devices 99 there is also a cyclically operating locking device 95 comprising an actuating rod 952 and a gripper 951 which can cooperate with a stationary mounted gripping element 96 and which can be cyclically locked and unlocked by pressure exerted on the actuating rod 952 by means of the gripping element 96 when the rear end position S2 is reached.

The locking device 95 can thus be locked by manually exerting pressure on it and unlocked again by exerting further pressure.

FIG. 3 shows a part of the displacement device 10 of FIG. 2 with the upper end piece of the mounting profile 14 connected to the upper guide carriage 5, which is displaceably supported in the upper guide rail 15 and which is connected to the drive device 2.

By connecting the drive device 2 to the mounting profile 14 or the guide carriage 5, it is no longer necessary to mount the drive device 2 on a rear wall, a partition wall 1D or a side wall 1A of the functional entity 1.

The upper guide carriage 5 comprises a carriage body 51 with a first carriage body part 511 supporting vertically oriented support rollers 591 and horizontally oriented guide rollers 592, and a second carriage body part 512 connected to the mounting profile 14. The two carriage body parts 511, 512 may be integrally connected to each other, but in this embodiment are connected to each other by a coupling part 55. The support rollers 591 are supported on a runner element 151 of the upper guide rail 15 and the guide rollers 592 are guided in a guide channel 152 of the upper guide rail 15. A buffer or damper 58 is inserted into the carriage body 51. Furthermore, the upper guide carriage 5 comprises a stop member 53 which can cooperate with a buffer or damper 78 on the front-sided stop device 7 (see FIG. 4).

The mounting profile 14 preferably has a mounting channel 143, in which the mounting hinges 131 are held positively and can be fixed by locking screws 1311.

The drive device 2 comprises a drive unit 21 with a housing 210, in which a spring mechanism 211 is arranged and a pulley 212 connected to the spring mechanism 211, on which the pull cord 22 is wound, is held rotatable. The spring mechanism 211 is preferably a driving spring, for example in the form of a spiral spring or a helical spring, which is tensioned or released when the pulley 212 is rotated. The pulley 212 is mounted turntable by means of a bearing shaft 215 (shown schematically). The spiral spring mechanism 211 also encloses the bearing shaft 215 and is firmly connected with a first end piece 2111 to the pulley 212 and directly or indirectly with a second end piece 2112 to the bearing shaft 215. The bearing shaft 215 is preferably firmly connected to the housing 210.

When the pull cord 22 is pulled out, the first end piece 2111 of the spring mechanism 211 is guided around the bearing shaft 215, while the second end piece 2112 of the spring mechanism 211 is held firmly. As soon as the pull cord 22 is released again, the pulley 212 is rotated back again by the tensioned spring mechanism 211. If the coupling element 221 at the end of the pull cord 22 is hooked onto a holding element 72, for example at the front-end position S1, and the mounting profile 14 is retracted into the door compartment 18, the pull cord 22 is pulled out of the drive unit 21, the cord pulley 212 is rotated and the spring mechanism 211 is tensioned. The mounting profile 14 can now be locked with the locking device 95 when it reaches the rear end position S2. As soon as this locking device is released, the cord pulley 212 is rotated back by the spring mechanism 211 and the pull cord 22 is retracted again and the mounting profile 14 is moved from the rear end position S2 to the front-end position S1. A door 11 connected to the mounting profile 14 is therefore automatically pulled out of the door compartment 18.

The pull cord 22 can be pulled out of the drive device 2 by means of the first adjustment device 3 according to FIG. 4 and/or by means of the second adjustment device X3 according to FIG. 5, if necessary, in order to tension the spring mechanism 211. The two adjustment devices 3, X3 can be used individually or in combination.

FIG. 4 shows the displacement device 10 of FIG. 2 with the upper guide carriage 5 and the drive device 2 according to FIG. 3. The mounting profile 14 is displaceable between the front-sided end position S1 and the rear-sided end position S2. The front-sided end position S1 is reached when the stop member 53 of the guide carriage 5 meets the stop damper or stop buffer 78 on the front stop device 7, which is preferably adjustable to set the front-sided end position S1. The mounting profile 14 is preferably pulled by the drive device 2 over the entire travel path from the rear end position S2 to the front-end position S1.

The pull cord 22 is guided from the drive device 2 via a first deflection pulley 231 and further pulleys 232 and 233 to a first adjustment device 3 mounted on the upper front stop device 7. As described below with reference to FIG. 5, the first deflection pulley 231 can be part of an optionally provided second adjustment device X3, which is provided, for example, for the coarse adjustment of the pre-tension of the drive device 2. For this purpose, the first deflection pulley 231 is held displaceable along the mounting profile 14 and lockable, which is symbolised with a dash-dotted arrow. By moving the first deflection pulley 231, the length of the path along which the pull cord 22 runs can be lengthened or shortened. The first adjustment device 3, on the other hand, contains a rotatable and lockable pull cord drum 33 (see FIG. 9) onto which the remote end of the pull cord 22 can be wound. A screwdriver T is shown which is inserted into the front of the first adjustment device 3 to release and, turn the pull cord drum 33 as required.

The first adjustment device 3 is explained in more detail below with reference to the other drawings.

The preferably provided holding device 4, which comprises two holding cables 421, 422, is described in more detail below with reference to FIG. 5. However, in all embodiments of the invention, any holding device 4 can be used with the inventive displacement device 10, by means of which a mounting profile 14 can be held vertically aligned and displaceable.

FIG. 5 shows the displacement device 10 of FIG. 2 with the holding device 4 of FIG. 4 and with the mounting profile 14 connected to the drive device 2 from which the pull cord 22 is guided via a second adjustment device X3 comprising a first deflection pulley 231 and via a second deflection pulley 232 to a holding element 72 which is held on the upper front-sided stop device 7. As already shown in FIG. 4, the front-sided stop device 7 can additionally be provided with a first adjustment device 3, as symbolically shown in FIG. 5.

The second adjustment device X3 comprises a deflection unit X33 which is displaceable along the mounting profile 14 and lockable and which is provided with the first deflection pulley 231. The deflection unit X33 is form-fittingly held in a guide channel 141 of the mounting profile 14 and is displaceable along the latter and can be form-fittingly and/or force-fittingly locked at a suitable position preferably by means of a locking device, such as a screw X32. The locking device can also be designed as a latching device and, for example, have a latching tongue that is connected to the deflection unit X33 and can engage in a latching or serration that is provided along the mounting profile 14 or is worked into the mounting profile 14.

By moving the deflection unit X33 along the mounting profile 14, the path from the pull cord pulley 212 to the second deflection pulley 232 can be lengthened or shortened. By lengthening this path, a corresponding length of the pull cord 22 is pulled out of the drive unit 21, the pull cord pulley 212 is rotated in the drive device 2 and the spring mechanism 211 is pre-tensioned accordingly. This adjustment can be done easily in a few steps.

FIG. 5 also shows the preferably provided holding device 4, which comprises two holding cables 421, 422. At the front side of the upper guide rail 15 the upper stop device 7 and at the front side of the lower guide rail 16 the lower stop device 8 is connected to the corresponding upper or lower guide rail 15, 16 by means of a mounting beam 711, 811 and clamping screws 712.

The upper front-sided stop device 7 comprises the holding element 72 for fixing the pull cord 22, a cable connection device 74 for the second holding cable 422, a rotary lever 75, the stop damper 78 and possibly mounting means for mounting the first adjustment device 3 if present. The rotary lever 75 serves to hold the mounting profile 14 in the front-end position S1. The upper cable connection device 74 comprises a mounting channel with an adjacent recess into which an end piece of the upper holding cable 422 can be inserted.

The second holding cable 422 is firmly held by the cable connection device 74 of the upper stop device 7. The cable connection device 84 of the lower stop device 8, on the other hand, comprises a setting sledge 842, which is displaceably mounted and adjustable by means of a setting screw 845. The setting screw 845 and the setting sledge 842 form a setting device 840. By operating the setting screw 845, the first holding cable 421 can be tightened or loosened and the mounting profile 14 can be aligned vertically.

The holding device 4 comprises the first front-sided cable connection device 84, a first lower roller unit 431 arranged at the lower end of the mounting profile 14, a first upper roller unit 411 arranged at the upper end of the mounting profile 14, and a first rear cable connection device 44 arranged at the rear end of the upper guide rail 15, and the first holding cable 421 connected with a first end piece to the first front cable connection device 84, guided counter-clockwise around the first lower roller unit 431 and clockwise around the first upper roller unit 411 and connected with a second end piece to the first rear cable connection device 44.

Further, the holding device 4 comprises the second front-sided cable connection device 74, a second upper roller unit 412 disposed at the upper end of the mounting profile 14, a second lower roller unit 432 disposed at the lower end of the mounting profile 14, and a second rear cable connection device 45 disposed at the rear end of the lower guide rail 16, and the second holding cable 422 connected with a first end piece to the second front cable connection device 74, routed clockwise around the second upper roller unit 412 and counter-clockwise around the second d lower roller unit 432 and connected with a second end piece to the second rear cable connection device 45.

FIG. 6a shows the upper front-sided stop device 7 and, connected thereto, the first adjustment device 3 of FIG. 4 from the rear. In this embodiment, the first adjustment device 3 is not integrated into the stop device 7 but is mounted on its underside. The pull cord 22 is guided via a third deflection pulley 233, which is held by the stop device 7, through the device body 71 of the stop device 7 downwards into the housing 38 of the first adjustment device 3, which can be closed by means of a cover 39 (see FIG. 6b).

Alternatively, the first adjustment device 3 can be integrated into the associated stop device 7 or 8. In these embodiments, the housing 38 of the first adjustment device 3 forms an integral part of the device body 71 or 81 of the associated stop device 7 or 8. The present embodiment, on the other hand, has the advantage that the first adjustment device 3 can be dismounted and/or manipulated and maintained in a simple manner, particularly in the case of sliding devices 10 which do not yet have a drive device 2.

FIG. 6b shows the upper stop device 7 and, connected thereto, the first adjustment device 3 of FIG. 6a with the cover 39 detached from the housing 38 from the front side, from which the first adjustment device 3 is adjustable. The housing 38 of the first adjustment device 3, which is connected to the device body 71 of the stop device 7 by mounting elements and a connecting element 372, such as a connecting screw or a press pin, comprises a housing chamber 380, in which the rotatable adjustment element or the pull-pull cord drum 33 is supported rotatable about the drum axis x (see FIG. 7a) and displaceable by a required amount along the drum axis x. The pull cord 22 is guided via the third deflection pulley 233 to the pull cord drum 33 and connected to it. In this preferred embodiment, the pull cord drum 33 comprises a holding element 339 to which the end piece 221 (see FIG. 3) of the pull cord 22 can be coupled. The end piece 221 is, for example, a coupling rod or a coupling anchor, which is preferably guidable through a coupling channel 338 in the pull cord drum 33 and connectable to the holding element 339. Preferably, the holding element 339 is formed as a recess in which the end piece 221 can be anchored (see FIG. 7a).

At the front side, the pull cord drum 3 is preferably connected in one piece with a tool coupling part 31, which is arranged coaxially to the drum axis x. At the rear, the pull cord drum 33 is held by a bearing bush 34 which is rotatable and displaceable along the drum axis x. The pull cord drum 33 is mounted by means of the tool coupling part 31 in a tool chamber 3801 of the housing 38 (see FIG. 7b) on the one hand and in the bearing bush 34 rotatable and displaceable on the other hand (see FIG. 8).

At the front of the pull cord drum 33, locking elements 32 are also provided which can cooperate with at least one counter element 383 (see FIG. 7b) on an inner wall of the housing 38 to prevent the adjusted pull cord drum 33 from rotating automatically. To adjust the pull cord drum 33, the locking elements 32 of the pull cord drum 33 and the at least one counter element 383 provided in a locking chamber 3802 of the housing 38 (see FIG. 7b) must be decoupled from each other.

The bearing bush 34 is preferably held in the housing 38 so that it cannot be moved or rotated. By means of a drum spring 35, the pull cord drum 33 is pushed away from the bearing bush 34 with a force vector running parallel to the drum axis x, so that the locking elements 32 provided on the front side of the pull cord drum 33 can interact with the counter element 383. The pull cord drum 33 must therefore be moved axially against the bearing bush 34 so that the locking elements 32 are decoupled from the counter element 383 and the pull cord drum 33 can be rotated and the pre-tension on the drive device 2 can be adjusted (see also FIG. 7a).

After coupling a tool to the tool coupling part 31, the pull cord drum 33 is therefore first moved axially against the bearing bush 34 to uncouple the locking elements 32 from the counter element 383 and then rotated as required to wind up the pull cord 22 and adjust the pre-tension on the drive device 2. After adjusting the pre-tension, the tool is retracted so that the pull cord drum 33 is moved back axially by the drum spring 35, the locking elements 32 and the counter element 383 engage each other again and the pull cord drum 33 is fixed with the adjusted pre-tension.

The figures of a “snail” and a “rabbit” on the front of the first adjustment device, next to the tool coupling part 31, symbolise that by turning the pull cord drum 33 anticlockwise the pre-tension can be increased and by turning the pull cord drum 33 clockwise the pre-tension can be reduced in order to set the desired acceleration and displacement speed of the mounting profile 14.

Into the cover 39, which is complementary to the housing 38, a locking element in the form of a mounting fork 399 is inserted, which allows the pull cord drum 33, the bearing bush 34 and the drum spring 35 to be fixed to the cover 39 and mounted in a simple manner. By means of the mounting fork 399 the drum spring 35 is pressed against the pull cord drum 33 and held in position so that the assembled assembly 33, 34, 35 can be conveniently inserted into the housing 38. For operation of the first adjustment device 3, the mounting fork 399 is removed and the drum spring 35 is activated, which then preferably rests against a part, such as a holding wall 382 of the housing 38 (see FIG. 7b).

FIG. 6c shows the front-sided stop device 7 and the connected first adjustment device 3 of FIG. 6a in a sectional view.

It is shown that the third deflection pulley 233 is mounted rotatably in the device body 71 of the stop device 7. The stop buffer 78, which has a buffer body 781, is mounted axially adjustable in the device body 71 by means of an adjustment screw 782.

Visible from the pull cord drum 33 is the transfer channel 338 through which the end piece 221 of the pull cord 22 passes. The mounting fork 399 has not yet been removed and the drum spring 35 is therefore not yet activated.

The bearing bush 34 has a bushing sleeve 341 and is firmly anchored with a bushing anchor 342 in the housing 38 of the first adjustment device 3. Inside the bushing sleeve 341 a slider 36 is provided, which is axially displaceable during rotation of the pull cord drum 33, preferably by means of a threaded rod 334 (see FIG. 8) connected to the pull cord drum 33, between a rear end stop, preferably formed by the rear side wall 381 of the housing 38 or a part of the bearing bush 34, and a front-end stop, preferably formed by a part of the pull cord drum 33. The number of rotations of the pull cord drum 33 in one and the other direction is therefore limited.

FIG. 6d shows the upper stop device 7 and the connected first adjustment device 3 of FIG. 6b in a sectional view.

Between the housing 38 and the device body 71 a space is kept free in which the locking lever 75 (see FIG. 5) can be inserted (not shown), which is supported by the partially exposed lever spring and can be fixed by means of a screw. By means of this locking lever, the mounting profile 14 can be fixed to the stop device 7.

FIG. 7a shows the first adjustment device 3 of FIG. 6b without cover 39. It is shown that the pull cord drum 33 has a winding body 333, to which a first drum wall 331 is connected at the front and a second drum wall 332 at the rear and which is provided with the transfer channel 338 and the moulded-in holding element 339.

Furthermore, it is shown that the bearing bush 34 has a bushing slot 3410 in the facing side of the bushing sleeve 341, which is exposed to the outside in a first part and is covered in a larger cylindrical part. A slider wing 361 of the slider 36 is guided in the bushing slot 3410 in such a way that the slider 36 is axially displaceable but not turnable. The slider 36 is displaceable through the entire bushing sleeve 341 between the second drum wall 332 of the pull cord drum 33 and the front side wall 381 of the housing 38. After the slider 36 has reached the second drum wall 332 on one side or the side wall 381 of the housing 38 on the other side, the pull cord drum 33 can no longer be turned, so that the pre-tension of the drive device 2 can only be adjusted within a predetermined range, which is preferably determined by means of the second adjustment device X3.

FIG. 7a further shows that four locking elements 32 are arranged on the first drum wall 331 at equal distances offset from each other. The locking elements 32 are wing-shaped or rib-shaped and run concentrically to the drum axis x radially outwards and are preferably integrally connected to the tool connection part 31 and/or the pull cord drum 33. The pull cord drum 33 can therefore be adjusted and locked with a quarter turn. After adjustment and locking of the pull cord drum 33, the pull cord drum 33 is held against rotation in one direction by the tensile force of the pull cord 22 and in the other direction by the locking elements 32 and the counter element 383.

The second drum wall 332 is in contact with the drum spring 35, which is still held by the mounting fork 399 and which is not activated.

FIG. 7a further shows a bolt 371, by means of which the cover 39 can be fixed, and the connecting element 372, by means of which the housing 38 of the first adjustment device 3 can be connected, for example, to the device body 71, 81 of the upper or lower stop device 7, 8.

FIG. 7b shows the housing 38 of the adjustment device 3 of FIG. 7a with a view of the housing chamber 380. The housing chamber 380 comprises a tool chamber 3801, in which the tool coupling part 31 is held rotatable and displaceable, a locking chamber 3802, into which a counter element 383 projects, and a drum chamber 3803, in which the pull cord drum 33 is held rotatable and displaceable, as well as a bushing chamber 3804 and an anchor chamber 3805, in which the bearing bush 34 is held. At the transition between the drum chamber 3803 and the bushing chamber 3804, a holding wall 382 results against which the drum spring of 35 rests after activation or after removal of the mounting fork 399.

FIG. 8 shows the pull cord drum 33, the bearing bush 34, the drum spring 35, the slider 36 aligned along the drum axis x, and the cover 39 in exploded view. The pull cord drum 33 comprises the winding body 333, the first drum wall 331 integrally connected to the locking elements 32 and the tool coupling part 31, and the second drum wall 332 integrally connected to a threaded rod 334 aligned coaxially with the drum axis x.

The bearing bush 34 has a bushing channel 340 passing through it from front to back to the bushing anchor 342, which is extended on opposite sides by the bushing slots 3410. The bushing channel 340 extends through the bushing anchor 342 and the housing 38 forms an end stop. In preferred embodiments, however, the bearing bush 34 forms this end stop, in which, for example, the bushing anchor 342 forms a closed plate that closes off the bushing channel 340 on one side. In this embodiment, the slider 36 can therefore only be inserted into the bearing bush 34 from the side of the bushing channel 340 facing the pull cord drum 33.

The slider 36, which has a threaded hole 360 and two slider wings 361 facing outwards, is screwed onto the threaded rod 334. The threaded rod 334 provided with the slider 36 is inserted into the bushing channel 340 in such a way that the bushing wings 361 are guided in the bushing slots 3410. The slider 36 can also be inserted into the bushing channel 340 from one side or the other and then connected to the threaded rod 334 of the pull cord drum 33.

The cover 39 is complementary to the housing 38 and comprises a tool chamber cover part 391, a locking chamber cover part 392, a drum chamber cover part 393, a bushing chamber cover part 394 and mounting holes 390 for inserting the mounting fork 399. The first drum wall 331 preferably abuts a wall piece 395 forming the transition between the anchor chamber cover part 392 and the drum chamber cover part 393 when mounting the pull cord drum 33, the bearing bush 34 and the drum spring 35, which is held by the mounting fork 399.

FIG. 9 shows the first adjustment device 3 of FIG. 4 during the adjustment process, in which the tool symbolised by an arrow has been connected to the tool coupling part 31 and the pull cord drum 33 has been moved against the bushing sleeve 34 and the drum spring 35 has been compressed accordingly to release the locking elements 32 from engagement with the counter element 383 (see FIG. 7b). In this position the pull cord drum 33 can be rotated until the slider 36 hits a stop member of the bearing bush 34 or the rear side wall 381 of the housing 38 on one side or the second drum wall 332 of the pull cord drum 33 on the other side. After setting the desired pre-tension of the drive device 2 or the driving spring 211, the tool is retracted. During this process, the pull cord drum 33 is pushed back by the drum spring 35 until the locking elements 32 engage again in the locking chamber 3802 and the pull cord drum 33 is locked.

FIG. 10 shows the auxiliary drive 9 of FIG. 2, which is held by the mounting profile 14 and which cooperates with a rear stop device 90 after the sliding door 11 has been pushed into the door compartment 18. The auxiliary drive 9 comprises a housing 93 and at least one extendable piston 91, which is supported by a spring element 92 and which engages the stop device 90 after the mounting profile 14 has entered the door compartment 18. The spring element 92 of the auxiliary drive 9 is tensioned as soon as the mounting profile 14 moves towards the rear end position S2 inside the door compartment 18. After reaching the rear end position S2, the spring element 32 of the auxiliary drive 9 is loaded and can support the drive device 2 at the beginning of the departure of the mounting profile 14 towards the front-sided end position S1.

Furthermore, the mounting profile 14 is connected to a cyclically operating locking device 95 comprising an actuating rod 952 and a gripper 951 which cooperates with a stationary mounted gripping element 96 and is cyclically lockable and releasable by pressure on the actuating rod 952. By a first displacement of the actuating rod 952, which is arranged in a device housing 953 and supported by a spring, the gripper 951 is closed and by a second displacement of the actuating rod 952 the gripper 951 is opened again. The actuating rod 952 is preferably arranged coaxially to the central axis of the gripper 951, so that the actuating rod 952 can be actuated by the gripping element 96, which is gripped and released by the gripper 951. The gripping element 96 is arranged on a stop plate of the stop device 90, which is attached to the intermediate wall 1D of the functional entity 1. The displacement path of the actuating rod 952 is indicated by a dotted line. Shortly before reaching the rear end position S2, it meets the gripping element 96 and is pushed back by it, whereby the gripping device 95 is actuated and coupled to the gripping element 96.

Furthermore, damping devices 99 with damping piston 991 are provided, which hit the stop plate of the stop device 90 as soon as the mounting profile 14 reaches the rear end position S2.

### LIST OF REFERENCE

1 functional entity, piece of furniture or room unit

1A side walls

1B upper board

1C lower board

1D partition wall

10 displacement device

100 furniture opening

11 door, possibly foldable sliding door

111 first door element of the foldable sliding door

112 second door element of the foldable sliding door

131 mounting hinges

1311 locking screws

132 door hinges

14 mounting profile

141 first guide channel

143 mounting channel

15 upper guide rail

150 support rail

151 runner element

152 guide channel

16 lower guide rail

18 door compartment

2 drive device

21 drive unit

210 housing

211 spring mechanism, driving spring

2111 first end piece of the spring mechanism

2112 second end piece of the spring mechanism

212 pull cord pulley

215 bearing shaft

22 pull cord

221 coupling part, possibly end piece of the pull cord

231 first deflection pulley

232 second deflection pulley

233 third deflection pulley

29 connecting part

3 adjustment device

31 tool coupling part

32 locking elements

33 rotatable adjustment element, pull cord drum

331 first drum wall

332 second drum wall

333 winding body, preferably cylindrical

334 threaded rod

338 transfer channel

339 holding element

34 bearing bush

340 bushing channel

3410 bushing slots

341 bushing sleeve

342 bushing anchor

35 drum spring

36 slider

360 threaded hole

361 slider wing

371 retaining bolt

372 connecting element, connecting screw/press pin

38 housing

380 housing chamber

3801 tool chamber

3802 locking chamber

3803 drum chamber

3804 bushing chamber

3805 anchor chamber

381 stop wall

382 holding wall

383 counter element, holding nose

386, 387 mounting hook

39 cover

390 mounting holes

391 tool chamber cover

392 locking chamber cover

393 drum chamber cover

394 bushing chamber cover

399 mounting fork

X3 adjustment device

X32 locking screw

X33 displaceable adjustment element, deflection unit

X330 threaded hole für die locking screws

X331 coupling part

4 holding device

41 upper pair of rollers

411 first upper roller unit

412 second upper roller unit

421 first holding cable

422 second holding cable

43 lower pair of rollers

431 first lower roller unit

432 second lower roller unit

44 rear upper cable connection device

45 rear lower cable connection device

5 upper guide carriage

5F front carriage

51 upper carriage body

511 first carriage body part

5111 mounting sword

5112 holding plate

512 second carriage body part

5120 damper channel

5121 fixing screw

53 stop member

55 coupling part

58 integrated carriage damper

591 support rollers

592 guide rollers

6 lower guide carriage

61 lower carriage body

68 integrated carriage damper

692 guide rollers

7 upper stop device

71 device body

711 mounting beam

712 clamping screws

72 holding element

74 front-sided second cable connection device

75 upper locking lever

78 upper stop damper or stop buffer

781 buffer body

782 adjustment screw

79 spacer rollers

8 lower stop device

81 device body

811 mounting beam

812 clamping screws

82 locking lever

84 front-sided first cable connection device

840 setting device

842 setting sledge

845 setting screw

85 lower locking lever

89 spacer rollers

9 auxiliary drive

90 rear stop device

91 drive piston of the auxiliary drive 9

92 drive spring of the auxiliary drive 9

93 housing of the auxiliary drive 9

95 cyclically operating locking device

951 gripper

952 actuating rod

953 device housing

96 gripping element

99 damping device

991 damping piston

S driveway of the mounting profile 14

S1 front-sided end position of the mounting profile 14

S2 rear end position of the mounting profile 14

x drum axis x

1. A displacement device for the installation in a door compartment of a functional entity
with a drive device, which comprises a spring mechanism, a pull cord pulley coupled to the spring mechanism, and a pull cord, which is wound onto the pull cord pulley and guided via at least one deflection pulley up to a holding element,
with a mounting profile (14),
which mounting profile is connected or connectable by mounting hinges to a single-part or multi-part door and is held vertically aligned and displaceable by a holding device;
which mounting profile is connected on an upper end piece to an upper guide carriage that is supported displaceably on an upper guide rail or is connected on a lower end piece to a lower guide carriage that is supported displaceably on a lower guide rail; and
which mounting profile, connected to the drive device, is automatically displaceable between a rear-sided end position at the rear-side of the displacement device and a front-sided end position at the front-side of the displacement device; and
with an adjustment device, with which a pre-tension on the spring mechanism of the drive device can be set,
wherein,
the adjustment device is arranged separated from the drive device and comprises an adjustment element which is rotatable and lockable or displaceable and lockable and which adjustment element cooperates with the pull cord of the drive device in such a way that the pull cord is pullable out of the drive device by rotation or displacement of the adjustment element to set a corresponding pre-tension of the spring mechanism.

2. The displacement device according to claim 1, wherein, the adjustment device is arranged stationary at the front-end position, and in that the rotatable adjustment element is a pull cord drum, which is supported in a device housing, which has a housing chamber, so as to be rotatable about a drum axis and lockable, wherein the pre-tension of the spring mechanism is adjustable by turning and locking the pull cord drum.

3. The displacement device according to claim 1, wherein,
the upper guide rail is connected at a front-end to an upper stop device which determines the front-end position, or
the lower guide rail is connected at a front-end to a lower stop device which determines the front-end position, or
the upper guide rail is connected at a front-end to an upper stop device and the lower guide rail is connected at a front-end to a lower stop device, which determine the front-end position, and
the adjusting device is mounted on the upper stop device or on the lower stop device or is integrated into the upper stop device or into the lower stop device.

4. The displacement device according to claim 2, wherein, the pull cord drum is connected on a first side eccentrically or coaxially to the drum axis with a tool coupling part.

5. The displacement device according to claim 4, wherein,
the housing chamber comprises a tool chamber, in which the tool coupling part is held rotatable and displaceable, a locking chamber, into which at least one counter element projects, and a drum chamber, in which the pull cord drum is held rotatable and displaceable, and in that the pull cord drum has a winding body onto which the pull cord can be wound, and to which a first drum wall adjoins on one side and a second drum wall adjoins on the other side,
the first drum wall is connected to the tool coupling part and to at least one locking element which is rotatable inside the locking chamber against the counter element, and
the second drum wall abuts against an elastic element or a helical spring which presses the pull cord drum against the locking chamber, so that the at least one locking element can only be released from the locking chamber when the pull cord drum is axially displaced.

6. The displacement device according to claim 5, wherein,
the pull cord drum has, adjoining the second drum wall, a threaded rod which is aligned coaxially with the drum axis and by which a slider is held rotatable,
the housing of the adjustment device has a bushing chamber, in which a bearing bush is held, which has a bushing channel, into which the threaded rod projects and within which the slider is held axially displaceable but not turnable and is displaceable by rotation of the pull cord drum in one direction or in opposite directions to an end stop.

7. The displacement device according to claim 6, wherein, the slider comprises at least one slider wing which projects into a bush slot provided in the bearing bush and which extends parallel to the drum axis.

8. The displacement device according to claim 2, wherein, the pull cord drum forms the holding element or has a holding element or in that the winding body of the pull cord drum has a transfer channel through which the pull cord can be guided to the holding element, which is arranged or formed on the winding body as a hook or latching depression.

9. The displacement device according to claim 2, wherein, the housing chamber of the housing can be closed off by a cover into which a fixing element or mounting fork can be inserted, by means of which the pull cord drum and the drum spring can be fixed to the cover.

10. The displacement device according to claim 1, wherein, the displaceable adjustment element of the adjustment device is a deflection unit,
which deflection unit holds a first deflection pulley via which the pull cord is guided from the drive device to a second deflection pulley and further to a stationary holding element,
which deflection unit is directly or indirectly connected to the mounting profile,
which deflection unit is displaceably mounted with respect to the drive device and with respect to the second deflection pulley that is directly or indirectly connected to the mounting profile or to one of the guide carriages, and
wherein the pre-tension of the spring mechanism is adjustable by moving and locking the deflection unit.

11. The displacement device according to claim 10, wherein, the deflection unit is held form-fittingly and/or force-fittingly in a guide channel of the mounting profile and is displaceable and lockable.

12. The displacement device according to claim 10, wherein,
the upper guide rail is connected at the front-end to an upper stop device which determines the front-sided end position, or
the lower guide rail is connected at the front-end to a lower stop device which determines the front-sided end position, or
the upper guide rail is connected at the front-end to an upper stop device and the lower guide rail is connected at the front-end to a lower stop device, which determine the front-sided end position, and
the holding element is arranged on the upper stop device or on the lower stop device.

13. The displacement device according to claim 1, wherein, the drive device comprises a housing which is connected to the mounting profile or to the upper guide carriage or to the lower guide carriage.

14. The displacement device with a first adjustment device according to claim 1 and a second adjustment device which is a deflection unit,
which deflection unit holds a first deflection pulley via which the pull cord is guided from the drive device to a second deflection pulley and further to a stationary holding element,
which deflection unit is directly or indirectly connected to the mounting profile,
which deflection unit is displaceably mounted with respect to the drive device and with respect to the second deflection pulley that is directly or indirectly connected to the mounting profile or to one of the guide carriages, and
wherein the pre-tension of the spring mechanism is adjustable by moving and locking the deflection unit.

15. A functional entity, piece of furniture or room unit, with at least one door compartment, in which a mounting profile, which is connected by hinges to a partial or multi-part door, is displaceably held by means of a displacement device according to claim 1.
